(19) United States
(12) Patent Application Publication
(10) Pub. No.: US 2010/0278548 A1
(43) Pub. Date: Nov. 4, 2010

(54) AUTOMATED CLEANER FOR A CHARGING DEVICE

(75) Inventors: Aaron M. Burry, Ontario, NY (US); Bruce E. Thayer, Spencerport, NY (US); Michael F. Zona, Holley, NY (US)

Correspondence Address: PATENT DOCUMENTATION CENTER;XEROX CORPORATION, 100 CLINTON AVE SOUTH, MAILSTOP: XRX2-020, ROCHESTER, NY, 14644, US

(73) Assignee: XEROX CORPORATION, Norwalk, CT (US)

(21) Appl. No.: 12/432,984

(22) Filed: Apr. 30, 2009

(51) Int. Cl. G03G 15/00; G03G 15/02

(52) U.S. Cl. 399/49; 399/50; 399/100

(57) ABSTRACT

An image forming apparatus including: a first charging device for charging an imageable surface; recording means for recording an electrostatic latent image on the imageable surface; developing means for developing the electrostatic latent image with developer; a second charging device for transferring a developer image on the imageable surface onto an a substrate; control means for setting a value of the bias of either the first charging device or the second charging device from an operating bias to a testing bias; test pattern forming means for forming test patterns on the imageable surface at operating bias and said testing bias; test patterns detection means for scanning non-uniformity of the test patterns, and means for associating non-uniformity of the test patterns to a reliability condition of either the first charging device and/or second charging device.

### CROSS-REFERENCE TO RELATED APPLICATIONS

Reference is made to commonly-assigned copending U.S. patent application Ser. No. ______ (Attorney Docket No. 20081235-US-NP, filed concurrently herewith, entitled “AUTOMATED CLEANER FOR A CHARGING DEVICE”, by Burry et al., the disclosure of which is incorporated herein.

### BACKGROUND

This invention relates generally to a charge generating device, and more particularly concerns a method and apparatus for cleaning a charging device.

In a typical electrophotographic printing process, a photoconductive member is charged to a substantially uniform potential so as to sensitize the surface thereof. The charged portion of the photoconductive member is exposed to a light image of an original document being reproduced. Exposure of the charged photoconductive member selectively dissipates the charges thereon in the irradiated areas. This records an electrostatic latent image on the photoconductive member corresponding to the informational areas contained within the original document. After the electrostatic latent image is recorded on the photoconductive member, the latent image is developed by bringing a developer material into contact therewith.

Generally, the developer material comprises toner particles adhering triboelectrically to carrier granules. The toner particles are attracted from the carrier granules to the latent image forming a toner powder image on the photoconductive member. The toner powder image is then transferred from the photoconductive member to a copy sheet. The toner particles are heated to permanently affix the powder image to the copy sheet. In printing machines such as those described above, corona devices can be used to perform a variety of functions in the printing process.

For example, corona devices aid the transfer of the developed toner image from a photoconductive member to a transfer member. Likewise, corona devices aid the conditioning of the photoconductive member prior to, during, and after deposition of developer material thereon to improve the quality of the electrophotographic copy produced thereby. Both direct current (DC) and alternating current (AC) type corona devices are used to perform these functions. One form of a corona charging device comprises a corona electrode in the form of an elongated wire connected to a high voltage AC/DC power supply. Alternatively, a charging device may comprise an array of pins integrally formed from a sheet metal member. Another alternative charging device is a biased charge roll (BCR) type device.

The scorotron is similar to the pin corotron, but is additionally provided with a screen or control grid disposed between the coronode and the photoconductive member. The screen is held at a lower potential approximating the charge level to be placed on the photoconductive member. The scorotron provides for more uniform charging and prevents overcharging.

A problem with electrophotographic printing process is the accumulation of silica and other contamination on the corona electrode. These accumulations are adhered onto the corona electrode due to the high voltage placed on the corona electrode during operation. These accumulations can deteriorate the image quality and can interrupt the continuous use of these printers by causing print defects, such as dark streaks on the printed pages. For some cases, these defects could be cured by simply wiping the contamination from the small thin corona electrode. Similar accumulation can occur on the surface of a BCR generating similar problems.

Unfortunately the rate of charger contamination, and the build-up of the associated non-uniformity in the output prints, is not presently easy to measure. As a result, contamination related failures are highly unpredictable and can vary greatly from one machine to another. Thus, unscheduled maintenance events (UMs) due to charger contamination are still fairly common. In an attempt to decrease the number of UMs, service technicians will often change the charge device, prior to its actual end of life, while servicing the machine for other reasons to prevent having to return for a charger UM event at a later time. Both UM events and the replacement of charge devices prior to their end of life result in increased system run cost. A method for measuring the actual contamination state of the charge device, and perhaps for predicting the future onset of contamination related PQ streaks, could help to improve system run costs.

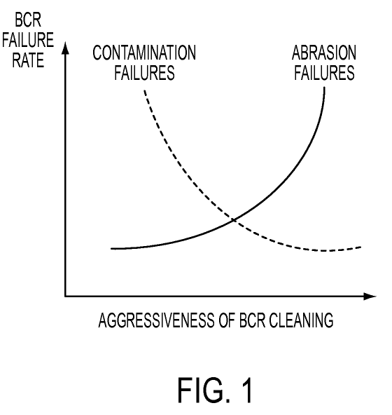

Additionally, in many cases the charge device cleaner can actually have negative impacts on the function of the charge device itself over time. For instance, in biased charge roll (BCR) systems the cleaning device can often lead to abrasion of the surface of the BCR. This abrasion then results in the onset of dark streaks print quality (PQ) failures in the output prints. The difficulty lies in designing a cleaner for the charging device that is aggressive enough to remove the unwanted contamination and films (thereby sufficiently extending the life of the charger) while not being so aggressive as to cause unwanted impacts to the charger (e.g. abrasion). This is a difficult balance to optimize particularly when some of the free parameters are fixed at design time (e.g. the force applied to the cleaning device). FIG. 1 is a model that illustrates the required design tradeoff for a BCR charge device cleaner. The difficulties associated with this tradeoff are further exacerbated by the fact that the contamination level of the charge device can be significantly impacted by a variety of factors: temperature and relative humidity, age of the devices, air flow, availability of contaminants, etc. Similarly, it is difficult to predict the likelihood of damage to the charge device for a given cleaning action as there are a variety of noise factors which affect this as well.

The present disclosure obviates the problems noted above by providing a method for detecting and measuring charge device contamination levels prior to the critical threshold that would result in print quality streaks in the output customer prints. By operating the charge device in a much more stressful (less robust) mode during a test mode, the degree of streaks due to charger contamination can actually be enhanced. By appropriate sensing, the contamination level of the charge device can therefore be measured/characterized prior to the onset of PQ defects (streaks) in the output customer prints. Such information could then be used to drive a variety of service or process control related actions, thereby improving overall system run cost.

### SUMMARY OF THE INVENTION

There is provided an image forming apparatus including a first charging device for charging an imageable surface; recording means for recording an electrostatic latent image on said imageable surface; developing means for developing the electrostatic latent image with developer; a second charging device for transferring a developer image on the imageable surface onto a substrate; control means for setting a value of the bias of either said first charging device or said second charging device from an operating bias to a testing bias; test pattern forming means for forming test patterns on the imageable surface at operating bias and said testing bias; test patterns detection means for scanning non-uniformity of the test patterns, and means for associating non-uniformity of the test patterns to a reliability condition of either said first charging device and/or second charging device

Other features of the present invention will become apparent as the following description proceeds and upon reference to the drawings, in which:

FIG. 1 is a model that illustrates design tradeoffs for a BCR charge device cleaner;

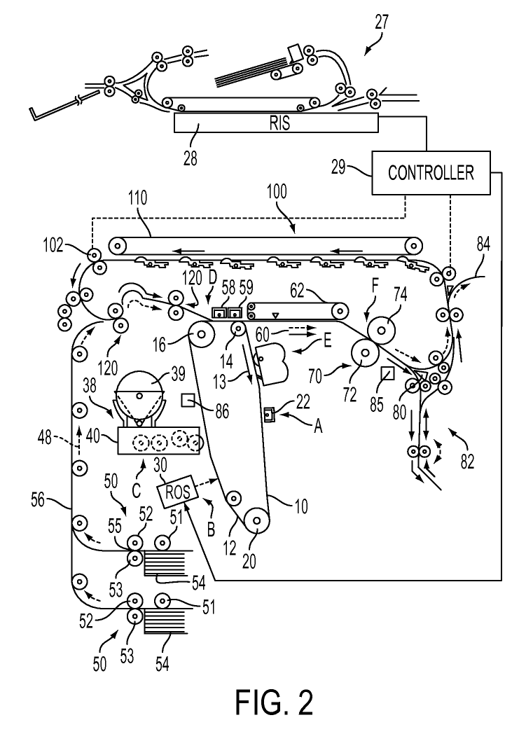

FIG. 2 is a schematic elevational view of a typical electrophotographic printing machine utilizing the present invention;

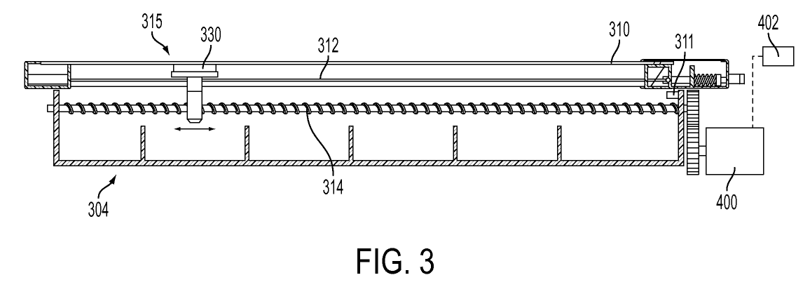

FIG. 3 is a schematic view illustrating a charging device with the cleaning device of the present disclosure;

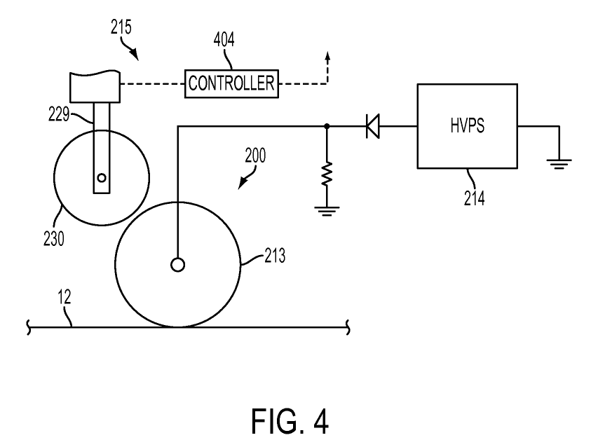

FIG. 4 is a schematic view illustrating another embodiment of the charging device with the cleaning device of the present disclosure;

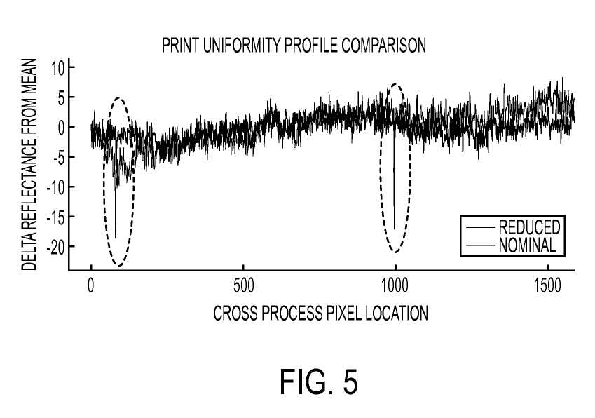

FIG. 5 illustrates a comparison of non-uniformity profiles for sample prints made under operating bias and test bias; and

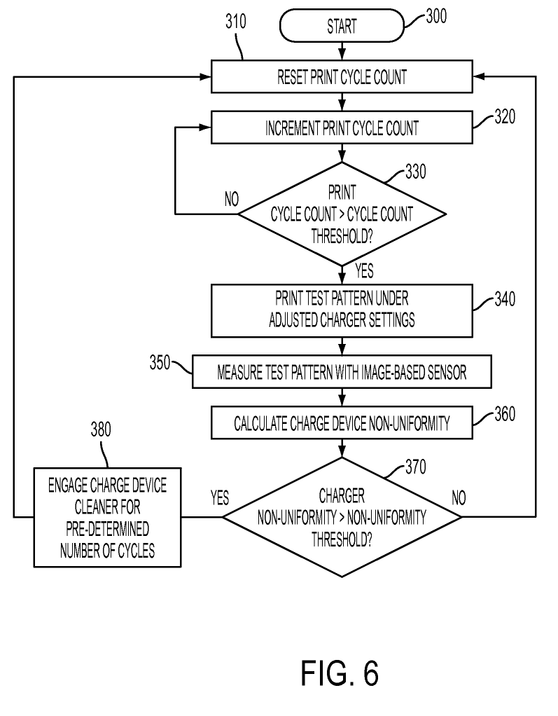

FIGS. 6-8 are flow diagrams illustrating possible operation of the cleaning system of the present disclosure.

While the present disclosure will be described in connection with a preferred embodiment thereof, it will be understood that it is not intended to limit the disclosure to that embodiment. On the contrary, it is intended to cover all alternatives, modifications, and equivalents as may be included within the spirit and scope of the disclosure as defined by the appended claims.

For a general understanding of the features of the present disclosure, reference is made to the drawings. In the drawings, like reference numerals have been used throughout to identify identical elements.

FIG. 2 schematically depicts an electrophotographic printing machine incorporating the features of the present disclosure therein. It will become evident from the following discussion that the present invention may be employed in a wide variety of devices and is not specifically limited in its application to the particular embodiment depicted herein.

Referring to FIG. 2 of the drawings, an original document is positioned in a document handler 27 on a raster input scanner (RIS) indicated generally by reference numeral 28. The RIS contains document illumination lamps, optics, a mechanical scanning drive and a charge coupled device (CCD) array. The RIS captures the entire original document and converts it to a series of raster scan lines. This information is transmitted to an electronic subsystem (ESS) which controls a raster output scanner (ROS) described below. FIG. 2 schematically illustrates an electrophotographic printing machine which generally employs a photoconductive belt 10. Preferably, the photoconductive belt 10 is made from a photoconductive material coated on a ground layer, which, in turn, is coated on an anti-curl backing layer. Photoconductive belt 10 moves in the direction of arrow 13 to advance successive portions sequentially through the various processing stations disposed about the path of movement thereof. Photoconductive belt 10 is entrained about stripping roller 14, tensioning roller 20 and drive roller 16. As drive roller 16 rotates, it advances photoconductive belt 10 in the direction of arrow 13. Initially, a portion of the photoconductive surface passes through charging station A.

At charging station A, a corona generating device indicated generally by the reference numeral 22 charges the photoconductive belt 10 to a relatively high, substantially uniform potential. At an exposure station, B, a controller or electronic subsystem (ESS), indicated generally by reference numeral 29, receives the image signals representing the desired output image and processes these signals to convert them to a continuous tone or grayscale rendition of the image which is transmitted to a modulated output generator, for example the raster output scanner (ROS), indicated generally by reference numeral 30. Preferably, ESS 29 is a self-contained, dedicated minicomputer. The image signals transmitted to ESS 29 may originate from a RIS as described above or from a computer, thereby enabling the electrophotographic printing machine to serve as a remotely located printer for one or more computers. Alternatively, the printer may serve as a dedicated printer for a high-speed computer. The signals from ESS 29, corresponding to the continuous tone image desired to be reproduced by the printing machine, are transmitted to ROS 30. ROS 30 includes a laser with rotating polygon mirror blocks.

The ROS will expose the photoconductive belt to record an electrostatic latent image thereon corresponding to the continuous tone image received from ESS 29. As an alternative, ROS 30 may employ a linear array of light emitting diodes (LEDs) arranged to illuminate the charged portion of photoconductive belt 10 on a raster-by-raster basis. After the electrostatic latent image has been recorded on photoconductive substrate 12, belt 10 advances the latent image to a development station, C, where toner, in the form of liquid or dry particles, is electrostatically attracted to the latent image using commonly known techniques.

The latent image attracts toner particles from the carrier granules forming a toner powder image thereon. As successive electrostatic latent images are developed, toner particles are depleted from the developer material. A toner particle dispenser, indicated generally by the reference numeral 39, dispenses toner particles into developer housing 40 of developer unit 38.

With continued reference to FIG. 2, after the electrostatic latent image is developed, the toner powder image present on photoconductive belt 10 advances to transfer station D. A print sheet 48 is advanced to the transfer station, D, by a sheet feeding apparatus, 50. Preferably, sheet feeding apparatus 50 includes a nudger roll 51 which feeds the uppermost sheet of stack 54 to nip 55 formed by feed roll 52 and retard roll 53. Feed roll 52 rotates to advance the sheet from stack 54 into vertical transport 56.

Vertical transport 56 directs the advancing sheet 48 of support material into the registration transport 120, past image transfer station D to receive an image from photoreceptor belt 10 in a timed sequence so that the toner powder image formed thereon contacts the advancing sheet 48 at transfer station D. Transfer station D includes a corona generating device 58 which sprays ions onto the back side of sheet 48. This attracts the toner powder image from photoconductive substrate 12 to sheet 48. The sheet is then detacked from the photoreceptor by corona generating device 59 which sprays oppositely charged ions onto the back side of sheet 48 to assist in removing the sheet from the photoreceptor. After transfer, sheet 48 continues to move in the direction of arrow 60 by way of belt transport 62 which advances sheet 48 to fusing station F.

Fusing station F includes a fuser assembly indicated generally by the reference numeral 70 which permanently affixes the transferred toner powder image to the copy sheet. Preferably, fuser assembly 70 includes a heated fuser roller 72 and a pressure roller 74 with the powder image on the copy sheet contacting fuser roller 72. The pressure roller is cammed against the fuser roller 72 to provide the necessary pressure to fix the toner powder image to the copy sheet. The fuser roller is internally heated by a quartz lamp (not shown). Release agent, stored in a reservoir (not shown), is pumped to a metering roll (not shown). A trim blade (not shown) trims off the excess release agent. The release agent transfers to a donor roll (not shown) and then to the fuser roller 72. The sheet then passes through fuser assembly 70 where the image is permanently fixed or fused to the sheet. After passing through fuser 70, a gate 80 either allows the sheet to move directly via output 84 to a finisher or stacker, or deflects the sheet into the duplex path 100, specifically, first into single sheet inverter 82. That is, if the sheet is either a simplex sheet, or a completed duplex sheet having both side one and side two images formed thereon, the sheet will be conveyed via gate 80 directly to output 84.

Scanning of test patterns can be on accomplished by scanning the sheet. Test pattern scanner 85 scans selected sheets having test patterns thereon. The selected sheets have test patterns thereon are conveyed via gate 80 directly to output 84. Alternatively, scanning of test patterns can be accomplished by scanning the developed test pattern on the photoconductive substrate prior to transfer with test pattern scanner 86. Test pattern scanners 85 and 86 includes an optical array or scanbar sensor adapted to measure toner mass on various substrates, preferably the optical array sensor extends along the full process width of the image forming apparatus. The scanned image data is sent to controller 29 whereupon the scanned image is analyzed for uniformity.

However, if the sheet is being duplexed and is then only printed with a side one image, the gate 80 will be positioned to deflect that sheet into the inverter 82 and into the duplex path 100, where that sheet will be inverted and then fed to acceleration nip 102 and belt transports 110, for recirculation back through transfer station D and fuser 70 for receiving and permanently fixing the side two image to the backside of that duplex sheet, before it exits via exit path 84. After the print sheet is separated from photoconductive substrate 12 of photoconductive belt 10, the residual toner/developer and paper fiber particles adhering to photoconductive substrate 12 are removed therefrom at cleaning station E.

Cleaning station E includes a rotatably mounted fibrous brush in contact with photoconductive substrate 12 to disturb and remove paper fibers and a cleaning blade to remove the nontransferred toner particles. The blade may be configured in either a wiper or doctor position depending on the application. Subsequent to cleaning, a discharge lamp (not shown) floods photoconductive substrate 12 with light to dissipate any residual electrostatic charge remaining thereon prior to the charging thereof for the next successive imaging cycle.

The various machine functions are regulated by controller 29. The controller is preferably a programmable microprocessor which controls all of the machine functions hereinbefore described. The controller 29 provides a comparison count of the copy sheets, the number of documents being recirculated, the number of copy sheets selected by the operator, time delays, jam corrections, etc. Conventional sheet path sensors or switches may be utilized to keep track of the position of the document and the copy sheets.

Turning next to FIG. 3, focusing on an embodiment of a charging device with cleaning device of the present disclosure, as illustrated the grid 310 is installed in the frame 304. Frame 304 has a groove which supports grid 310 therein. Wire 312 is positioned below grid 310. The charging devices include end blocks, which support wire 312. The cleaning device of the present disclosure employs annular cleaning pads for the grid and the grid side of the wire. Both cleaning pads are mounted on a circular base with a mechanism to rotate the base a fraction of a turn each time the cleaner returns to the home position. For example one design rotates the pads by 45° with each cleaning cycle. In this case, the wire and grid are each effectively cleaned by eight different cleaning pads. If each of the eight orientations cleans a few strips of the wire, the various strips will overlap so that over time, the entire wire will be cleaned thoroughly.

Cleaning device 315 is driven along the inner portion of charging device by a lead screw 314 being rotated by motor 400. Cleaning device 315 has a scrub pad 330 on the top surface thereof for cleaning any particles (ie toner or debris) adhering to grid 310 as the cleaning device moves along the charging device. Wire cleaning pads remove any particles (i.e., silica or debris) adhering to wire 312 as the cleaning carriage moves along the charging device Cleaning device 315 is controlled by controller 402, the operation of which will be described infra.

FIG. 4 illustrates another embodiment of a charging device with a cleaning device of the present disclosure. This embodiment features a bias charge roll 200. In various exemplary embodiments, the bias charge roll 200 comprises a charging member 213 disposed opposite to the surface of the movable charged body, that is, the surface of the photoconductive substrate 12 in the exemplary embodiment shown, and a power source 214 that applies a voltage to the charging member 213. A voltage is applied to the charging member 213 by this power source 214 to produce electric discharge between the charging member 213 and the surface of the photoconductive substrate 12, and the surface of the photoconductive substrate 12 is charged to a predetermined polarity.

The charging member 213 is structured in any of various types as explained later. The exemplary charging member 213 shown in FIG. 4 is cylindrically formed, with the shaft made of metal such as stainless steel and the outer layer is made of a conductive elastomer. When charging the charged body, the charging member 213 is, in various exemplary embodiments, positioned in a non-contact state with respect to the surface of the charged body. In other exemplary embodiments, the charging member is positioned in contact with the surface of the charged body. The exemplary charging member 213 shown in FIG. 4 is disposed in contact with the photoconductive substrate 12. Cleaning device 215 has a scrub pad 230 for cleaning any particles (i.e., toner or debris) adhering to the BCR as the cleaning device engages into contact with the charging device via cam assembly 229. In some embodiments, the scrub pad 230 may be a stationary foam pad or fibrous brush. In alternate embodiments, this device may be a foam roller. The engagement of cam assembly 229 is controlled by controller 402, the operation of which will be described infra.

In normal operation of the BCR, a voltage obtained by superimposing an AC voltage on a DC voltage is applied to the charging member 213, and the photoconductive substrate 12 is charged to the same potential as the applied DC voltage. In various exemplary embodiments the superimposed voltage of the DC voltage and the AC voltage is applied to the charging member 213 to produce electric discharge between the charging member 213 and the surface of the charged body, and charge is applied to the charged body. As explained above, by applying not only the DC voltage but also the AC voltage, in various exemplary embodiments the charge uniformity on the surface of the photoconductive substrate 12 is increased.

Applicants have found that most charging systems are designed to operate in a fairly robust region of the actuator latitude space. For example, most BCR chargers for color engines are operated in AC mode with fairly substantial peak-to-peak voltages. This assists in ensuring that the photoreceptor (P/R) is charged to a fairly uniform level despite reasonably wide variations in operating parameters (environment, contamination of the BCR, etc). Instead of operating the charge device in its designed, robust regime, it is possible to instead operate the device at a more stressful (less robust) set of actuator settings during a diagnostic/sensing mode. For example, for an AC BCR this would involve operating the device in DC-only mode (or at least at a substantially reduced AC peak-to-peak voltage). At these less robust settings, the charge voltage on the P/R coming out of the BCR nip will be much more susceptible to the state of contamination or abrasion of the charger. Therefore, the associated print defect level can actually be enhanced by operating the device in this fashion.

By printing test patterns while operating the charging device in this diagnostic (less robust) mode of operation, it is possible to enhance the amplitude of the print quality artifacts/defects related to the state of the charging device. The test patterns used in this less robust mode of operation are typically chosen to further enhance the potential defects. In an exemplary embodiment, these test patterns would be mid-range halftones (e.g. 50% area coverage) for each of the individual color separations. This set of test patterns typically provides high sensitivity to the types of artifacts (e.g. streaks) that are related to the contamination/abrasion state of the charge device. By using a test pattern scanning sensor, e.g. 85 or 86, it is possible to capture images of the mass structure. These images can then be analyzed by the controller 29 to extract various features and/or measurements of the non-uniformity structure.

The analysis of the captured images can be conducted using a number of different methods. In an exemplary embodiment, the mean of the image in the process direction is calculated to produce an inboard-outboard non-uniformity profile. This profile is then analyzed to identify large amplitude spikes. In general, these large amplitude spikes in the uniformity profile correspond to streak defects in the prints. FIG. 5 shows comparisons of non-uniformity profiles (inboard/outboard) for sample prints made under nominal (BCR AC≈1800Vpp) and reduced (BCR AC≈1300Vpp) BCR settings in a printer as the type of FIG. 2. The results shown are in units of scanner reflectance and the profile means have been removed to show only the deltas from the means. Note the downward spikes in these uniformity profiles which indicate various levels of dark streaks in the associated prints. For the scans under reduced charger actuator settings, the amplitudes of the spikes have been substantially increased over those at nominal actuator settings. This can also be visually observed in the output prints under both operating conditions. Applicants have observed that under certain charge device contamination/abrasion conditions, the vertical dark streaks in the print at nominal actuator settings are barely detectable. However, these streaks become prominently visible under reduced actuator settings. Experimental data has shown that streaks that have not yet become visible in the prints at nominal actuator settings are easily seen at reduced (less robust) charger settings. Thus, through the sensing method the amplitudes of the streak levels can be significantly increased during sensing, thereby greatly improving the ability to accurately measure the charger contamination profile (i.e., the “contamination state” of the charge device).

Having in mind the construction and the arrangement of the principal elements thereof, it is believed that a complete understanding may now be had from a description of its operation. During the charging device testing mode: controller 402 sets a value of the bias of either charging device 22 or transfer charging devices 58 and 59 from an operating bias to a testing bias. The value of the operating bias upon formation of a normal image is substantially different from a value of the testing bias upon formation of the test pattern. The test pattern is formed and developed via ESS 29 and ROS 30 on the photoconductive substrate 12. Test patterns are formed at the operating bias and the testing bias. The test patterns are scanned for non-uniformity by image sensor 86 adjacent to the photoconductive substrate 12, or transferred to a substrate and scanned for non-uniformity by image sensor 85 or document scanner 28.

In one embodiment, the ESS 29 processes the scanned test patterns and associates a non-uniformity value to the test patterns. This non-uniformity value is then treated as representative of the reliability condition of the charging device. If the non-uniformity value exceeds a predefined threshold value a feed back signal is generated to enable cleaning system 215 to clean the charging device. In another embodiment, the feed back signal is sent to user interface (not shown) or to a remote site to notify the user or service personnel of the condition or need of replacement of the charging device.

The defect enhancement is done employing a test patch preferably in an inter-document zone to enable early detection of impending failure modes. Measurements of the enhanced defect level could be made through an in-situ full-width array (FWA) optical sensor, or through an offline flatbed scanner. Simple approaches could even make use of visual interpretation of test prints by a service technician during a diagnostic mode to determine whether failure of the charger was imminent. Once again, the non-uniformity profile is substantially enhanced through the proposed sensing method, thereby making any of the proposed sensors more effective.

The sensing method enables early detection of impending charger failure. In its simplest form, this type of information can be used by a service representative to determine the expected remaining life of a charging device (without having to wait for charging related streaks failures to occur in the customer prints). In more advanced implementations remote diagnostics applications can be utilized to enable the machine to periodically make such measurements in an automated fashion thereby determining the health state of the charge device. This information can then be used to flag the customer (or service representative) for re-order of a new charge device (prior to actual onset of PQ failure). This prevents machine downtime, unscheduled service calls, and/or wasted prints for charge devices that start to fail in the middle of long customer jobs.

As earlier noted by the applicants, a typical engagement of the charger cleaning device is based upon such things as print count or pixel count. Applicants have found that there can be a great deal of variability in the amount of charger contamination that actually occurs. In addition, it is often the case that the charger cleaning device can impart damage to the charger over time. For instance, in BCR applications the BCR cleaner has been observed to cause abrasion of the surface of the BCR that results in dark streaks print failures in the prints. In fact, under some operating conditions these abrasion-related streaks onset well before contamination related streaks would without any charger cleaner installed in the system. Thus, in some cases the charger cleaning device can actually shorten the useable life of the overall charging subsystem.

Applicants have found that prior methods to deal with these issues are improved BCR materials that are more resistant to contamination and abrasion, improved BCR cleaner devices, and improvements in the prediction methods for estimating the actual contamination state of the charger. However, hardware and materials related approaches can be problematic/difficult due to design constraints and the difficulties associated with identifying/sourcing materials with the desired properties. Estimation based approaches (feed-forward) are difficult since it is troublesome to accurately predict the rate of contamination and/or the contamination state of the charger under all operating conditions and environments.

A desirable factor of the present disclosure is that it has a feedback based approach to keep the charge device clean with minimal negative impacts. In other words, a system which would measure the actual contamination level, or contamination state, of the charge device and take appropriate action to maintain an acceptable level of contamination without imparting unnecessary stress on the charge device itself.

An embodiment of the invention provides a feedback based approach to the operation of the charging subsystem's cleaning device in a xerographic print engine. Rather than estimating the contamination level of the charger, the actual contamination state is measured and used to determine the appropriate corrective action. This set of possible corrective actions would include adjusting the charge device cleaning rate, adjusting the aggressiveness of the charge device cleaner, increasing the frequency of the charge device cleaning cycles, etc. Utilizing the proposed feedback approach, the life of the charging system could be optimized while maintaining acceptable output print quality (i.e. no print streaks).

FIG. 6 illustrates a flow chart wherein a controller periodically measures the charge device non-uniformity level. When the level is unacceptably high the controller engages the charge device cleaner for a fixed duration. Step 300 indicates the start of the process; next at step 310 is the reset print cycle count; at step 320 is the Increment print cycle count.

At step 330 the print cycle count is compared to the cycle count threshold; if the print count is not greater than the cycle count threshold the process returns to step 320; if the print count is greater than the cycle count threshold the process goes to step 340 wherein the test pattern is printed under adjusted charger settings; at step 350 the test pattern is measured with an image-based sensor; at step 360 the charge device non-uniformity is calculated.

At step 370 the charge device non-uniformity is compared to the non-uniformity threshold; if the charge device non-uniformity is not greater than the threshold the process goes back to step 310; if the charge device non-uniformity is greater than the threshold then step 380 is initiated wherein the charge device cleaner is engaged for a predetermined number of cycles.

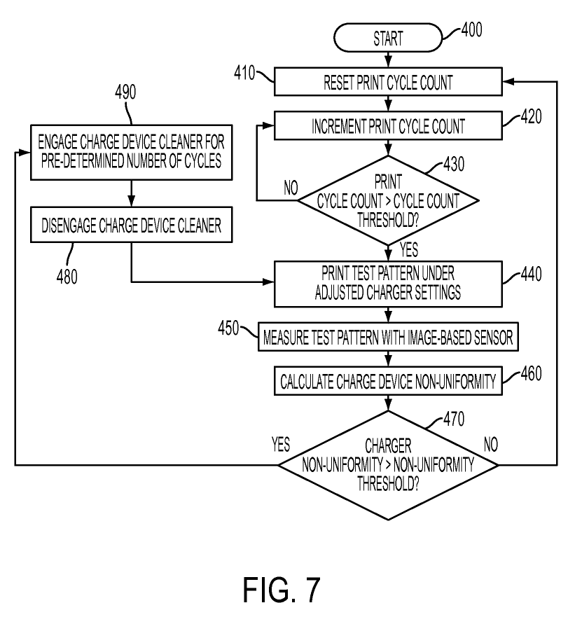

FIG. 7 illustrates a flow chart wherein the controller periodically measures the charge device non-uniformity level. When the level is unacceptably high the controller engages the charge device cleaner for a fixed duration and repeats until the non-uniformity level is below the threshold. This would limit the engagement of the charge device cleaner—only using it when needed. Step 400 indicates the start of the process; next at step 410 is the reset print cycle count; at step 420 is the Increment print cycle count.

At step 430 the print cycle count is compared to the cycle count threshold; if the print cycle count is not greater than the threshold, the process returns to step 420, if it is greater the process goes to step 440 where the test pattern is printed under adjusted charger settings; at step 450 the test pattern is measured with an image-based sensor; at step 460 the charge device non-uniformity is calculated.

At step 470 the charge device non-uniformity is compared to the non-uniformity threshold; if the non-uniformity level is not greater than the non-uniformity threshold the process goes back to step 410; if the non-uniformity level is greater than the non-uniformity threshold, then step 490 is initiated wherein the charge device cleaner is engaged for a pre-determined number of cycles then disengaged at step 480 and the process returns to step 440 where another test pattern is printed; the steps 460, 470, 490 are repeated until step 470 charge non-uniformity is below the threshold value.

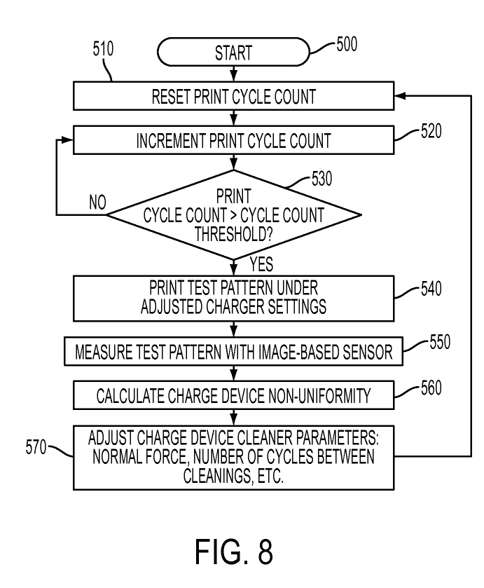

FIG. 8 illustrates a flow chart wherein a controller periodically measures the charge device non-uniformity level. The controller then uses this measurement to dynamically adjust the parameters for the charge device cleaner. This would include parameters such as: normal force applied to the cleaning device, frequency of engagement of the cleaning device, amount of time left engaged, etc. The controller dynamically adjusts said cleaner parameters thereby to maintain the contamination level on the bias charging roll sufficiently low to prevent contamination related print quality defects while also to minimize the degree of cleaning action (and therefore the potential for damage to the bias charging roll). Step 500 indicates start of the process; next at step 510 is the reset print cycle count; at step 520 is the Increment print cycle count.

At step 530 the print cycle count is compared to the cycle count threshold; if the print cycle count is not greater than the threshold, the process returns to step 520, if it is greater the process goes to step 540 where the test pattern is printed under adjusted charger settings; at step 550 the test pattern is measured with an image-based sensor; at step 560 the charge device non-uniformity is calculated.

At step 570, charge device cleaning parameters are calculated based on the calculated charge device non-uniformity, and are applied to charge device cleaning system. For example, the cleaning interval can be determined by the following equation:

$${T}_{c} ( k ) = α \frac{1}{{X}_{c} ( k - 1 )} + {Δ}_{T}$$

where T_{c}(k) is the time period between cleaning cycles at sampling instant k, α is an adjustable gain parameter, Δ_{T} is a minimum time between cleaner engagements, and X_{c}(k−1) represents the measured overall charger contamination level (in essence the health state of the charge device where larger values indicate more contamination/non-uniformity) at the prior sampling instant (k−1).

A force applied to the charge device cleaner is determined by the following equation:

F_{c}(k)=β·X_{c}(k−1)+Δ_{F}

where F_{c}(k) is the force applied to the cleaning device during the cleaning cycle at sampling instant k, β is an adjustable gain parameter, Δ_{F} is a minimum applied force, and X_{c}(k−1) represents the measured overall charger contamination level (in essence the health state of the charge device where larger values indicate more contamination/non-uniformity) at the previous sampling instant (k−1).

It is, therefore, apparent that there has been provided a device in accordance with the present invention which fully satisfies the aims and advantages hereinbefore set forth.

While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A system for sensing a reliability condition of a charging device, comprising:
an imageable surface, charging said imageable surface with the charging device;
a controller for setting a value of the operating bias of the charging device based upon formation of a normal image to a testing bias;
means for recording an electrostatic latent image of a test pattern on an imageable surface at said testing bias;
means for developing the electrostatic latent image of the test pattern with developer;
means for scanning the non-uniformity of the test pattern,
means for quantifying the non-uniformity of the test pattern; and
means for associating the non-uniformity of the test pattern to a reliability condition value of the charging device.

2. The system of claim 1, wherein said value of the operating bias upon formation of the normal image is substantially different from the value of the testing bias upon formation of the test pattern.

3. The system of claim 1, wherein said test patterns scanning means includes an optical array or scanbar sensor for measurement of toner mass on a substrate.

4. The system of claim 3, wherein said substrate includes one or more selected from the group consisting of a photoconductor surface, an intermediate transfer member, and a paper substrate.

5. The system of claim 3, wherein said optical array sensor extends along the full process width of said substrate.

6. The system of claim 1, further including means for cleaning said charging device.

7. The system of claim 1, wherein said associating means generates a feed back signal to enable adjustment of said cleaning means.

8. The system of claim 1, wherein said associating means generates a feed back signal that corresponds to the reliability condition of said charging device.

9. The system of claim 8, wherein said feedback signal includes an estimated number of cycles left in the useable life of the charge device.

10. The system of claim 8, wherein said feedback signal is provided to a user interface for user or service technician use.

11. The system of claim 8, wherein said feedback signal is provided to a remote diagnostics application.

12. A method for sensing a reliability condition of a charging device, comprising
charging an imageable surface with the charging device; said charging includes setting a value of the bias of the charging device from an operating bias to a testing bias;
recording an electrostatic latent image of a test pattern on an imageable surface;
developing the electrostatic latent image of the test pattern with developer;
scanning non-uniformity of the developed latent image of the test pattern,
determining a non-uniformity state of the developed latent image; and
associating the non-uniformity state to a reliability condition value of the charging device.

13. The method of claim 12, wherein the testing bias upon formation of the test pattern is substantially different from the operating bias value for the formation of a normal image.

14. The method of claim 12, wherein said scanning includes measuring toner mass on a substrate.

15. The method of claim 12, wherein said scanning includes scanning one or more selected from the group consisting of a photoconductor surface, an intermediate transfer member, and a paper substrate.

16. The method of claim 12, further including cleaning the charging device in response to the reliability condition.

17. The method of claim 12, wherein said associating includes generating a feed back signal to enable adjustment of said cleaning.
